(19) United States
(12) Patent Application Publication
(10) Pub. No.: US 2011/0311246 A1
(43) Pub. Date: Dec. 22, 2011

(54) Fixing Device, Image Forming Apparatus, and Method for Controlling Fixing Device

(76) Inventors: Noritaka MASUDA, Ibaraki (JP); Statoru TAO, Ibaraki (JP); Makoto HONDA, Ibaraki (JP)

(21) Appl. No.: 13/151,980

(22) Filed: Jun. 2, 2011

(30) Foreign Application Priority Data
Jun. 18, 2010 (JP) 2010-139610
Apr. 28, 2011 (JP) 2011-100776

(51) Int. Cl. G03G 15/20; G03G 13/20

(52) U.S. Cl. 399/33; 399/69; 399/67; 399/68

(57) ABSTRACT

A fixing device includes a fixing roller that is driven to rotate, a fixing belt that is driven by rotation of the fixing roller, and a driven roller that rotates along with the fixing belt. The fixing device also includes a pressing member that is pressed against the fixing roller with the fixing belt interposed therebetween to form a nip portion, a measuring unit that measures a rotation speed of the driven roller, and a control unit that adjusts a fixing condition based on the rotation speed of the driven roller.

### CROSS-REFERENCE TO RELATED APPLICATIONS

The present application claims priority to and incorporates by reference the entire contents of Japanese Patent Application No. 2010-139610 filed in Japan on Jun. 18, 2010 and Japanese Patent Application No. 2011-100776 filed in Japan on Apr. 28, 2011.

### BACKGROUND OF THE INVENTION

1. Field of the Invention

The present invention relates to a fixing device that heats and fuses a toner image on a recording medium so as to fix the toner image onto the recording medium, an image forming apparatus including the fixing device, and a method for controlling the fixing device.

2. Description of the Related Art

Electrophotographic image forming apparatuses such as copiers and printers include a fixing device that heats and fuses a toner image that is transferred onto a recording medium, and fix the toner image on the recording medium. Widely known examples of fixing devices used in the image forming apparatuses are a belt fixing device that heats and fuses a toner image on a recording medium by using heat from a fixing belt; and a roller fixing device that heats and fuses a toner image on a recording medium by using heat from a fixing roller. In particular, the fixing device that uses a belt for fixing (belt fixing device) is known as a system that can reduce start-up time and power consumption of the apparatuses because the belt fixing device can reduce heat capacity of a fixing member compared with that of the roller fixing device.

The belt fixing device is provided with a fixing belt that is stretched and supported by a plurality of roller members, such as a fixing roller, a heating roller, and a tension roller; a pressing roller that is pressed against the fixing roller with a fixing belt interposed therebetween so as to form a nip portion therebetween; and a pressure adjusting mechanism that adjusts the position of the pressing roller so as to set the width of the nip portion. When a recording medium is passing through the nip portion formed between the fixing belt and the pressing roller, a toner image on the recording medium is heated and fused by heat from the fixing belt while the heating roller is used as a heat source, and the toner image is applied with pressure to fix the toner image onto the recording medium.

In such a fixing device, variation occurs in the width of the nip portion (hereinafter, referred to as the nip width), resulting in unstable fixability, which is a problem. The nip width varies because of, for example, deformation of the fixing roller due to heat causing a rubber layer of the fixing roller to expand. As the nip width varies, there are changes in the amount of heat applied to the toner image on the recording medium that is passing through the nip portion. As a result, the fixability becomes unstable. To addresses this problem, for example, Japanese Patent Application Laid-open No. 2008-139724 discloses a technology for optimizing a fixing condition by detecting any variation in the nip width.

With the technology disclosed in Japanese Patent Application Laid-open No. 2008-139724, to prevent variation in the fixability due to deviation from a desired nip width, a displacement sensor such as a laser displacement meter is provided near a heating roller that also functions as a tension roller. Variation in the nip width is detected by detecting a positional deviation of the heating roller with use of the displacement sensor; and the feeding speed of the recording medium is changed or the temperature of the fixing belt is changed depending on the detection results.

However, in the technology disclosed in Japanese Patent Application Laid-open No. 2008-139724, because the displacement sensor is provided near the heating roller in order to detect the variation in the nip width, there is a problem in that, to prevent it from malfunctioning, the displacement sensor needs to be heavily protected from heat transmitted from the heating roller, leading to an increase in costs.

### SUMMARY OF THE INVENTION

It is an object of the present invention to at least partially solve the problems in the conventional technology.

According to an aspect of the present invention, there is provided a fixing device including: a fixing roller that is driven to rotate; a fixing belt that is driven by rotation of the fixing roller; a driven roller that rotates along with drive of the fixing belt; a pressing member that is pressed against the fixing roller with the fixing belt interposed therebetween to form a nip portion; a measuring unit that measures a rotation speed of the driven roller; and a control unit that adjusts a fixing condition based on the rotation speed of the driven roller.

According to another aspect of the present invention, there is provided an image forming apparatus including the fixing device mentioned above.

According to still another aspect of the present invention, there is provided a method for controlling a fixing device including: a fixing roller that is driven to rotate, fixing belt that is driven by rotation of the fixing roller, a driven roller that rotates along with drive of the fixing belt, and a pressing member that is pressed against the fixing roller with the fixing belt interposed therebetween to form a nip portion, the method including: measuring a rotation speed of the driven roller; and adjusting a fixing condition based on the rotation speed of the driven roller.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a color laser printer;

FIG. 2 is a diagram illustrating a detailed configuration of a fixing device;

FIG. 3A is a perspective view explaining an example of a setting position of a rotary encoder;

FIG. 3B is a perspective view explaining another example of the setting position of the rotary encoder;

FIGS. 4A and 4B are diagrams schematically illustrating how a nip width varies in the fixing device;

FIG. 5 is a diagram for explaining how to detect a variation in the nip width;

FIG. 6 is a flowchart of an example of concrete processing performed by a control unit when the fixing device is in operation;

FIG. 7 is a flowchart of an example of processing performed by the control unit during operation in a reference speed setting mode; and

FIG. 8 is a flowchart of an example of processing performed by the control unit during operation in a saturated thermal expansion detection mode.

### DETAILED DESCRIPTION OF THE PREFERRED EMBODIMENTS

Exemplary embodiments of a fixing device, an image forming apparatus, and a method for controlling the fixing device according to the present invention will be explained in detail below with reference to the accompanying drawings. In the following, a tandem color laser printer will be described as an example of the image forming apparatus of the present invention, and a belt fixing device will be described as an example of the fixing device of the present invention.

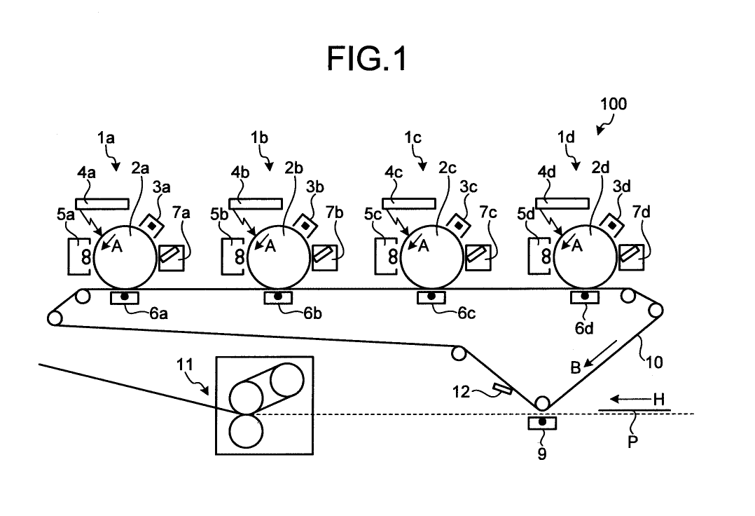

FIG. 1 is a schematic configuration diagram of a color laser printer 100 according to an embodiment. The color laser printer 100 includes image forming units 1a, 1b, 1c, and 1d for four colors Y (yellow), M (magenta), C (cyan), and K (black). The color laser printer 100 is of a tandem type in which the image forming units 1a, 1b, 1c, and 1d are arranged in series along a running direction of a transfer belt 10 (an arrow direction B in the figure).

The image forming units 1a, 1b, 1c, and 1d include photosensitive elements 2a to 2d; drum charging units 3a to 3d; exposing units 4a to 4d; developing units 5a to 5d; transfer units 6a to 6d; and cleaning units 7a to 7d, respectively. The photosensitive elements 2a to 2d are of drum-shaped structures, and are rotated in arrow directions A in the figure. The drum charging units 3a to 3d uniformly charge the photosensitive elements 2a to 2d that are rotated. The exposing units 4a to 4d scan the surfaces of the photosensitive elements 2a to 2d, which are charged by the drum charging units 3a to 3d, with laser light, thereby forming electrostatic latent images based on image data. The developing units 5a to 5d develop, with toner, the electrostatic latent images that are formed on the photosensitive elements 2a to 2d by exposure by the exposing units 4a to 4d. The transfer units 6a to 6d transfer the toner images, which are formed on the photosensitive elements 2a to 2d by development by the developing units 5a to 5d, onto the transfer belt 10. The cleaning units 7a to 7d clean the surfaces of the photosensitive elements 2a to 2d.

In the color laser printer 100, the toner images of four colors Y, M, C, and K formed by the image forming units 1a, 1b, 1c, and 1d are transferred onto the transfer belt 10 in a superimposed manner, so that a full four-color toner image is formed on the transfer belt 10. Upon reaching a sheet transfer unit 9, the toner image formed on the transfer belt 10 is transferred onto a recording medium P, which is conveyed in an arrow direction H in the figure to pass between the transfer belt 10 and the sheet transfer unit 9, by an operation of high voltage applied to the sheet transfer unit 9. Residual toner remaining on the transfer belt 10 is collected by a belt cleaning unit 12. The toner image transferred onto the recording medium P is fixed thereon by a fixing device 11.

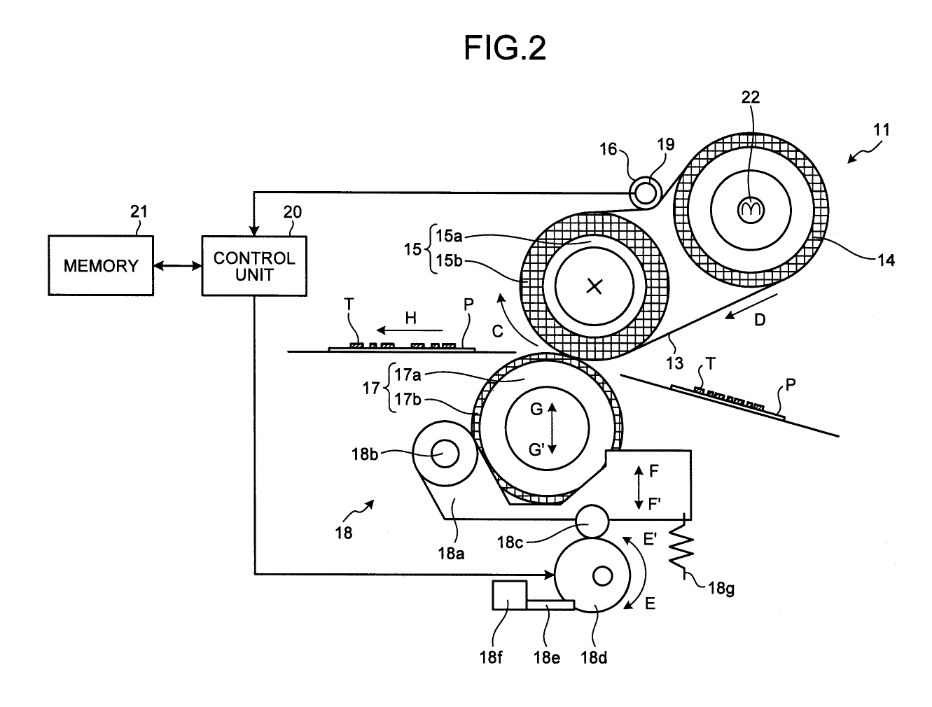

FIG. 2 is a diagram illustrating a detailed configuration of the fixing device 11. The fixing device 11 is a belt fixing device that uses a fixing belt 13 as a fixing member. The fixing device 11 includes a heating roller 14, a fixing roller 15, a tension roller 16, a pressing roller (pressing member) 17, a nip-width adjusting mechanism 18, a rotary encoder 19, a control unit 20, a memory 21, and the like, in addition to the fixing belt 13.

The fixing belt 13 as the fixing member is an endless belt with a multilayer structure, in which an elastic layer and a releasing layer are successively stacked on a base layer made of a resin material. The elastic layer of the fixing belt 13 is made of an elastic material such as fluoro rubber, silicone rubber, or foamed silicone rubber. The releasing layer of the fixing belt 13 is made of PFA (tetrafluoroethylene-perfluoroalkyl vinyl ether copolymer resin), polyimide, polyetherimide, PES (polyethersulfone), or the like. The provision of the releasing layer on the surface of the fixing belt 13 ensures releasability (detachablility) of a toner image T. The fixing belt 13 is stretched and supported by the three roller members (the heating roller 14, the fixing roller 15, and the tension roller 16).

The heating roller 14 is a thin cylindrical body made of a metallic material. A heater 22 (heat source) is fixed to the inside of the cylindrical body. The heater 22 is a halogen heater or a carbon heater, and is fixed to side plates of the fixing device 11 at both ends. The heating roller 14 is rotatably attached to the side plates of the fixing device 11 at both shaft ends via bearings. The heater 22 produces heat when output-controlled power is supplied by a power supply unit (alternating-current power supply). Radiant heat from the heater 22 heats the heating roller 14, and the surface of the fixing belt 13 heated by the heating roller 14 applies heat to the toner image T on the recording medium P. The output of the heater 22 is controlled based on a detection result of a temperature of the belt surface, which is detected by a temperature sensor such as a thermopile arranged so as to be opposed to the surface of the fixing belt 13.

The fixing roller 15 is a roller member formed of a core 15a that is made of stainless steel (for example, SUS304) or the like; and an elastic layer 15b that is made of fluoro rubber, silicone rubber, foamed silicone rubber, or the like and formed on the core 15a. The fixing roller 15 is rotatably attached to the side plates of the fixing device 11 at both shaft ends via bearings. The fixing roller 15 is driven to rotate clockwise (in the direction of an arrow C in the figure) by a fixing-roller driving unit, so that the fixing belt 13 runs in an arrow direction D in the figure.

The tension roller 16 is a driven roller that rotates along with running of the fixing belt 13 in the arrow direction D in the figure, and functions to apply a certain tension to the fixing belt 13.

The pressing roller 17 has basically the same configuration as that of the fixing roller 15. The pressing roller 17 is a roller member formed of a core 17a that is made of stainless steel (for example, SUS304) or the like, and an elastic layer 17b that is made of fluoro rubber, silicone rubber, foamed silicone rubber, or the like and formed on the core 17a.

In the fixing device 11, the pressing roller 17 is pressed against the fixing roller 15 with the fixing belt 13 interposed therebetween to form a nip portion. To form the nip portion, the fixing device 11 is configured so that the elastic layer 15b of the fixing roller 15 is thicker than the elastic layer 17b of the pressing roller 17. For example, the elastic layer 17b of the pressing roller 17 is 3 mm and the elastic layer 15b of the fixing roller 15 is 15 mm in thickness.

To stably fix the toner image T onto the recording medium P by heating and fusing the toner image T on the recording medium P, it is necessary to appropriately set the width of the nip portion (nip width) between the fixing roller 15 and the pressing roller 17 depending on the recording medium P to be used. However, the nip width is likely to vary over time, and the fixability may vary with variations in the nip width. The fixing device 11 according to the embodiment includes the nip-width adjusting mechanism 18 as a mechanism for adjusting the nip width when the nip width undergoes such a change.

The nip-width adjusting mechanism 18 includes a swing arm 18a. Roller bearings at both ends of the pressing roller 17 are rotatably supported by the swing arm 18a. The swing arm 18a can swing about a swing shaft 18b that is arranged at one end side of the swing arm 18a. A bearing 18c is fixed to another end side of the swing arm 18a. An eccentric cam 18d, which has a rotary shaft in a position deviated from the center of a circle, is arranged in such a manner that the eccentric cam 18d comes into contact with a bottom portion of the bearing 18c as shown in the figure. The eccentric cam 18d is driven by a nip-width adjusting motor. The eccentric cam 18d is provided with a shielding plate 18e. An eccentric cam position detecting unit 18f detects a position of the shielding plate 18e to recognize a reference position of the eccentric cam 18d.

The eccentric cam 18d is always maintained in contact with the bearing 18c by the tension of a swing arm spring 18g connected to the swing arm 18a. When the eccentric cam 18d is driven by the nip-width adjusting motor to rotate in an arrow direction E in the figure, the bearing 18c moves in an arrow direction F in the figure. As a result, the pressing roller 17 moves in an arrow direction G in the figure, leading to an increase in the nip width. When the eccentric cam 18d is driven by the nip-width adjusting motor to rotate in an arrow direction E′ in the figure, the bearing 18c moves in an arrow direction F′ in the figure. As a result, the pressing roller 17 moves in an arrow direction G′ in the figure, leading to a decrease in the nip width.

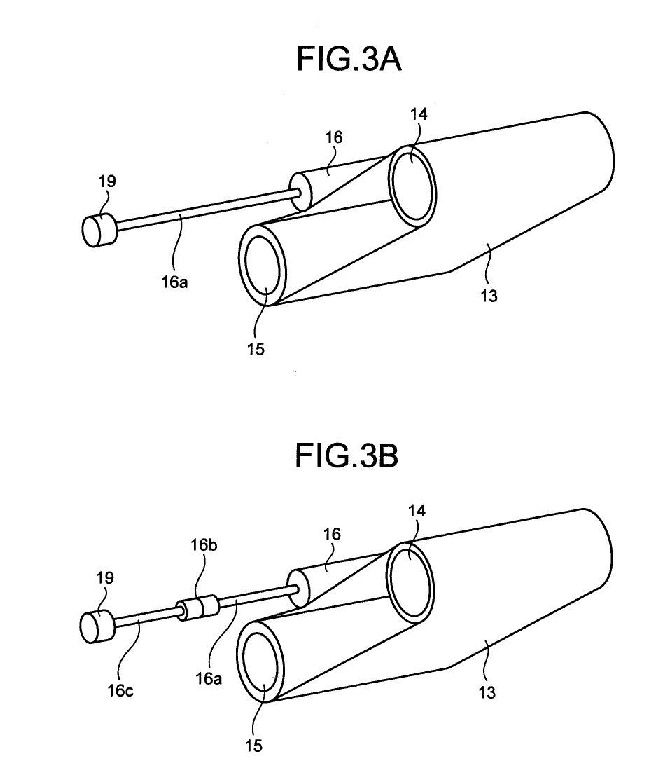

The rotary encoder 19 is arranged on a rotary shaft of the tension roller 16, and outputs a pulse signal corresponding to an angular speed of the tension roller 16. It is desirable to arrange the rotary encoder 19 at a position separated from a roller portion of the tension roller 16 that is in contact with the fixing belt 13. For example, as illustrated in FIG. 3A, a rotary shaft 16a of the tension roller 16 is extended; and the rotary encoder 19 is arranged on the end portion of the extended rotary shaft 16a. Furthermore, as illustrated in FIG. 3B, the rotary shaft 16a of the tension roller 16 is extended, a coupling 16b is arranged on the tip of the extended rotary shaft 16a, and a rotary shaft 16c, which is an additional member, is connected_{—} to the rotary shaft 16a via the coupling 16b. Then, the rotary encoder 19 is arranged on the end portion of the rotary shaft 16c that is connected to and rotated together with the rotary shaft 16a. In this manner, by arranging the rotary encoder 19 at the position separated from the roller portion of the tension roller 16, it is possible to extremely reduce heat transfer from the heating roller 14 and the fixing belt 13, which are used as heat sources, to the rotary encoder 19. Therefore, it is not necessary to take any measures to protect the rotary encoder 19 from heat or it becomes possible to extremely simplify a heat protection measure.

The control unit 20 calculates the angular speed of the tension roller 16 based on a pulse signal obtained from the rotary encoder 19 that is arranged on the rotary shaft of the tension roller 16. The control unit 20 compares the calculated angular speed of the tension roller 16 with a reference speed stored in the memory 21, and operates the nip-width adjusting mechanism 18 in accordance with the amount of change in the angular speed of the tension roller 16 with respect to the reference speed so as to adjust the nip width to an appropriate value. The reference speed is an angular speed of the tension roller 16, which is calculated by the control unit 20 when the nip width is maintained at an appropriate value. The reference speed is stored in the memory 21 in advance.

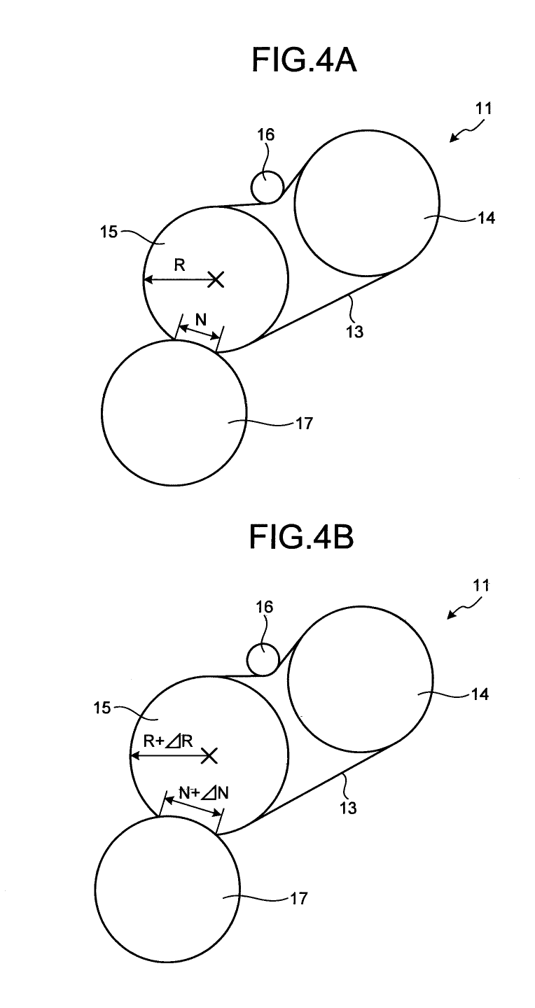

FIGS. 4A and 4B are diagrams schematically illustrating how the nip width varies in the fixing device 11. FIG. 4A illustrates the state of the fixing device 11 at the beginning of printing after the color laser printer 100 is powered on. FIG. 4B illustrates the state of the fixing device 11 at the end of printing of a predetermined number of sheets. At the beginning of printing, the fixing roller 15 is at a relatively low temperature. Suppose that the radius of the fixing roller 15 at this time is R, and the nip width at this time is N (see FIG. 4A). As the printing continues, the amount of heat applied to the fixing roller 15 gradually increases and the elastic layer 15b of the fixing roller 15 thermally expands, so that the radius of the fixing roller 15 increases to R+AR (ΔR≧0). Consequently, the nip width increases to N+ΔN (ΔN≧0) (see FIG. 4B). While the above example illustrates a case in which the nip width varies with deformation due to the expansion of the fixing roller 15, the nip width also varies when the position at which the pressing roller 17 is pressed against the fixing roller 15 changes.

If printing continues while the pressing roller 17 is maintained in the same press contact position even after the nip width has changed, the amount of heat applied to the toner image T on the recording medium P in the nip portion increases. Consequently, the toner image T on the recording medium P may adhere to the fixing belt 13, so that the toner image T may not be properly fixed on the recording medium P or glossiness of a color image may be reduced, resulting in failure to obtain desired fixability. In view of this, the fixing device 11 according to the embodiment indirectly detects a variation in the nip width from a change in the angular speed of the tension roller 16, and operates the nip-width adjusting mechanism 18 in accordance with the change in the angular speed of the tension roller 16 to adjust the nip width to an appropriate value, so that the desired fixability can be stably obtained.

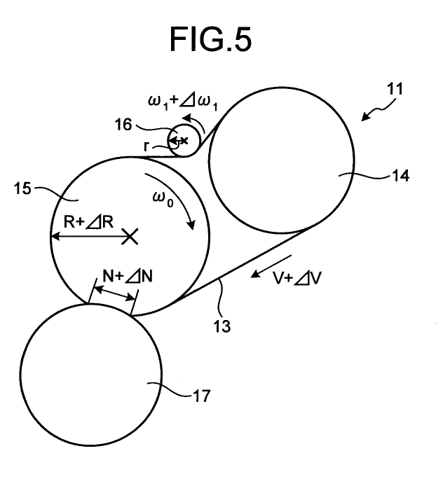

FIG. 5 is a diagram for explaining the principle of detection of a variation in the nip width. The fixing roller 15 is rotated at an angular speed ω₀ by a driving unit. When the fixing roller 15 thermally expands and the radius becomes R+ΔR, the nip width becomes N+ΔN as mentioned above. At the same time, the surface speed of the fixing belt 13 changes from the initial surface speed V to V+ΔV. The amount of change ΔV in the surface speed of the fixing belt 13 is represented by the following Equation (1).

ΔV=ω₀×ΔR (1)

Furthermore, the angular speed of the tension roller 16 that is rotating along with running of the fixing belt 13 changes from the initial angular speed ω₁ to ω₁+Δω₁. in accordance with the change in the surface speed of the fixing belt 13. Assuming that the radius of the tension roller is r, the amount of change Δω₁ in the angular speed of the tension roller 16 is represented by the following Equation (2).

Δω₁=ΔV/r (2)

Moreover, the following Equation (3) is obtained from the above Equations (1) and (2).

Δω₁=ω₀×ΔR/r (3)

Regarding the amount of variation AN in the nip width, it is known that the following Expression (4) is obtained, where “a” is a constant.

ΔN≈a×ΔR (4)

Therefore, the following Expression (5) is obtained from the above Equation (3) and Expression (4).

ΔN≈a×r×Δω₁/ω₀ (5)

Because a, r, and ω₀ are constant values, the amount of variation ΔN in the nip width can be determined by the amount of change Δω₁ in the angular speed of the tension roller 16. That is, a variation in the nip width can be indirectly detected by detecting a change in the angular speed of the tension roller 16.

With the principle described above, in the fixing device 11 according to the embodiment, the control unit 20 calculates the angular speed of the tension roller 16 with input of a pulse signal from the rotary encoder 19 that is arranged in the tension roller 16, and indirectly detects a variation in the nip width from a change in the angular speed of the tension roller 16. The control unit 20 operates the nip-width adjusting mechanism 18 in accordance with the amount of change in the angular speed of the tension roller 16, that is, the amount of variation in the nip width, to thereby adjust the nip width to an appropriate value.

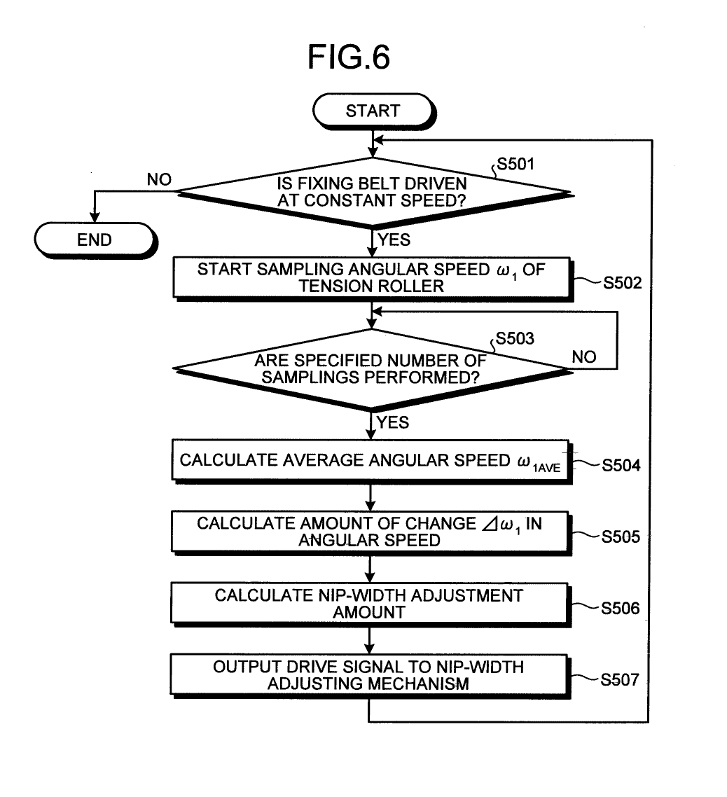

FIG. 6 is a flowchart of an example of concrete processing performed by the control unit 20 when the fixing device 11 of the embodiment is in operation. The flow of a series of processing performed by the control unit 20 will be described below with reference to the flowchart of FIG. 6.

When the processing of the flowchart of FIG. 6 is started, the control unit 20 determines whether the fixing belt 13 is driven at a constant speed (Step S501). When the fixing belt 13 is driven at the constant speed (Yes at Step S501), the processing proceeds to Step S502. When the fixing belt 13 is not driven at the constant speed (No at Step S501), the processing ends. Whether the fixing belt 13 is driven at the constant speed can be determined based on the state of the fixing-roller driving unit that rotates the fixing roller 15.

The control unit 20 calculates an angular speed ω₁ of the tension roller 16 at specified sampling intervals based on a pulse signal output from the rotary encoder 19, and accumulates the calculated angular speed ω₁ of the tension roller 16 in the memory 21 (Step S502).

The control unit 20 determines whether the angular speed ω₁ is sampled a specified number of times (Step S503). When the number of samplings is smaller than the specified number (No at Step S503), the control unit 20 repeats samplings of the angular speed ω₁ until the number of samplings reaches the specified number. Thereafter, when the number of samplings reaches the specified number (Yes at Step S503), the processing proceeds to Step S504. The number of times that the angular speed ω₁ of the tension roller 16 is sampled is set in accordance with a predetermined distance that the fixing belt 13 runs. To remove noise due to a local (sudden) variation in the speed of the fixing belt 13, it is desirable to set the number of samplings within a period corresponding to about one turn of the fixing belt 13. It may be possible to perform samplings of the angular speed ω₁ for a longer period because the thermal expansion of the fixing roller 15 progresses slowly.

The control unit 20 calculates an average angular speed ω_{1AVE} of the angular speeds ω₁ that are accumulated in the memory 21, where the number of the angular speeds ω₁ accumulated is the same as the specified number of samplings (Step S504).

The control unit 20 calculates an amount of change Δω₁ in the angular speed of the tension roller 16 based on a difference between a reference speed ω_{1INI} stored in advance in the memory 21 and the average angular speed ω_{1AVE} calculated at Step S504 (Step S505).

The control unit 20 calculates a nip-width adjustment amount corresponding to the amount of change Δω₁ in the angular speed of the tension roller 16 calculated at Step S505 (Step S506). The control unit 20 outputs a drive signal corresponding to the calculated nip-width adjustment amount to the nip-width adjusting mechanism 18 (Step S507) to cause the nip-width adjusting mechanism 18 to adjust the nip width. To calculate the nip-width adjustment amount in accordance with the amount of change Δω₁ in the angular speed of the tension roller 16, it may be possible to store a correspondence table for example, in which a relation between the amount of change Δω₁ in the angular speed and the amount of correction to the position of the eccentric cam 18d in the nip-width adjusting mechanism 18 is defined in advance, and determine the amount of correction to the position of the eccentric cam 18d in accordance with the amount of change Δω₁ in the angular speed based on the correspondence table.

In the fixing device 11 according to the embodiment, because the control unit 20 operates the above processing, it is possible to adjust the nip width to an appropriate value even when the nip width varies because of, for example, thermal expansion of the fixing roller 15. Therefore, favorable fixability can be stably obtained.

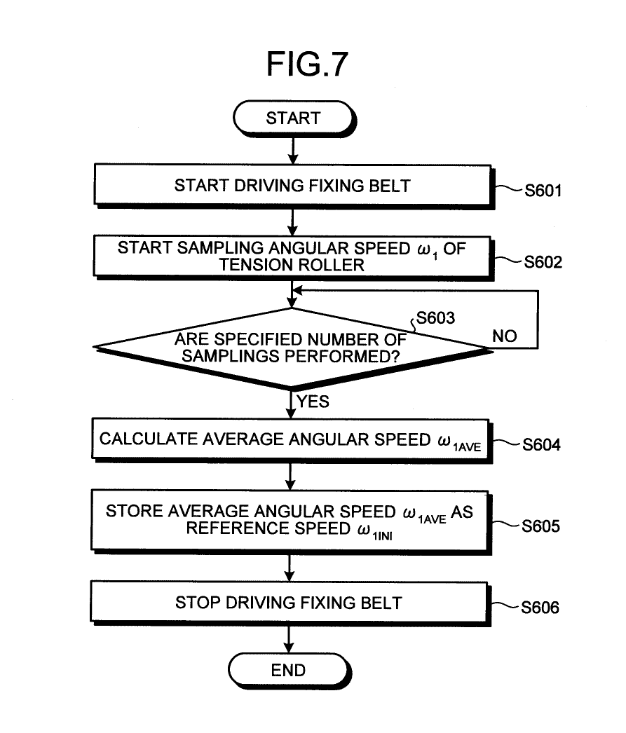

FIG. 7 is a flowchart of an example of processing performed by the control unit 20 in a reference speed setting mode, in which the reference speed ω_{1INI}, which is used for calculating the amount of change Δω₁ in the angular speed of the tension roller 16, is stored in the memory 21. The flow of a series of processing performed by the control unit 20 in the reference speed setting mode will be described below with reference to the flowchart of FIG. 7.

The series of processing of the flowchart of FIG. 7 starts when the reference speed setting mode is selected and the color laser printer 100 is operated by an operator immediately after the nip width is adjusted to a specified value through mechanical adjustment in the factory before shipment of the color laser printer 100 or on a product delivery site. The reference speed setting mode is activated immediately after the nip width is adjusted to the specified value so that the angular speed of the tension roller 16, which is obtained when the nip width is appropriate, can be stored in the memory 21 as the reference speed ω_{1INI}.

When the operation in the reference speed setting mode starts, the control unit 20 outputs a constant-speed rotation command to the fixing-roller driving unit to rotate the fixing roller 15 at a constant speed, thereby driving the fixing belt 13 at the constant speed (Step S601).

The control unit 20 calculates the angular speed ω₁ of the tension roller 16 at specified sampling intervals based on a pulse signal output from the rotary encoder 19, and accumulates the calculated angular speed ω₁ of the tension roller 16 in the memory 21 (Step S602).

The control unit 20 determines whether the angular speed ω₁ is sampled a specified number of times (Step S603). When the number of samplings is smaller than the specified number (No at Step S603), the control unit 20 repeats samplings of the angular speed ω₁ until the number of samplings reaches the specified number. When the number of samplings reaches the specified number (Yes at Step S603), the processing proceeds to Step S604. It is desirable to set the number of times that the angular speed ω₁ of the tension roller 16 is sampled so as to correspond to about one turn or even more than one turn of the fixing belt 13 in order to remove noise as described above.

The control unit 20 calculates an average angular speed ω_{1AVE} of the angular speeds ω₁ that are accumulated in the memory 21, where the number of the angular speeds ω₁ accumulated is the same as the specified number of samplings (Step S604).

The control unit 20 stores the average angular speed ω_{1AVE} calculated at Step 5604 in the memory 21 as the reference speed ω_{1INI} (Step S605). The control unit 20 stops driving the fixing belt 13 (Step S606), and ends the series of processing in the reference speed setting mode.

The above processing in the reference speed setting mode is performed immediately after the nip width is adjusted to the specified value in a factory before shipment of the color laser printer 100 or on a product delivery site. However, it is possible to perform the processing in the reference speed setting mode even immediately after the nip-width adjusting mechanism 18 adjusts the nip width upon detection of a variation in the nip width as described above. In this case, the reference speed ω_{1INI} stored in the memory 21 is updated with a new value calculated by the processing that is performed immediately after the nip-width adjusting mechanism 18 adjusts the nip width. If the reference speed ω_{1INI} is updated after the nip-width adjusting mechanism 18 adjusts the nip width, it becomes possible to adjust the nip width to an appropriate value even when the fixing roller 15 undergoes irreversible deformation with a variation in the nip width.

As described above, the fixing device 11 according to the embodiment adjusts the nip width by indirectly detecting a variation in the nip width based on a change in the angular speed of the tension roller 16 rather than directly detecting and feeding back a variation in the nip width. Therefore, some errors may occur in detecting the nip width. When the nip-width adjustment amount is large, the nip-width adjustment control is largely influenced by an error, resulting in reducing the accuracy. Meanwhile, when the thermal expansion of the fixing roller 15 reaches a saturation state, the above-mentioned deformation of the fixing roller 15 can be suppressed because of the saturated expansion, and the amount of variation in the nip width decreases. Therefore, if the expansion of the fixing roller 15 is maintained in the saturation state when the nip width is mechanically adjusted by an operator or a serviceman in a factory before shipment or on a product delivery site, it is possible to decrease the nip-width adjustment amount that is to be applied when printing is performed by actually operating the color laser printer 100. As a result, it is possible to reduce the influence of the error that may occur by indirectly detecting the nip width. More specifically, when the nip width is mechanically adjusted while the expansion of the fixing roller 15 is in the saturation state, the nip-width adjustment amount is increased only when the fixing roller 15 is at a low temperature, for example, immediately after the color laser printer 100 is powered on. However, because initialization operation continues for a few minutes immediately after the color laser printer 100 is powered on, printing is not performed during this period. Therefore, it is possible to reduce printing with a large nip-width adjustment amount. As a result, it is possible to minimize the adverse influence on a printed object.

From the above viewpoint, the fixing device 11 according to the embodiment has a thermal expansion saturation detection mode for detecting whether the thermal expansion of the fixing roller 15 is in the saturation state, as an operation mode of the color laser printer 100 to be used before the nip width is mechanically adjusted by a factory operator or a serviceman. In this mode, the control unit 20 determines whether the thermal expansion of the fixing roller 15 is in the saturation state. When the control unit 20 determines that the thermal expansion of the fixing roller 15 is in the saturation state, the control unit 20 notifies a factory operator or a serviceman that the thermal expansion of the fixing roller 15 is saturated by displaying message on a display panel or by outputting audio message.

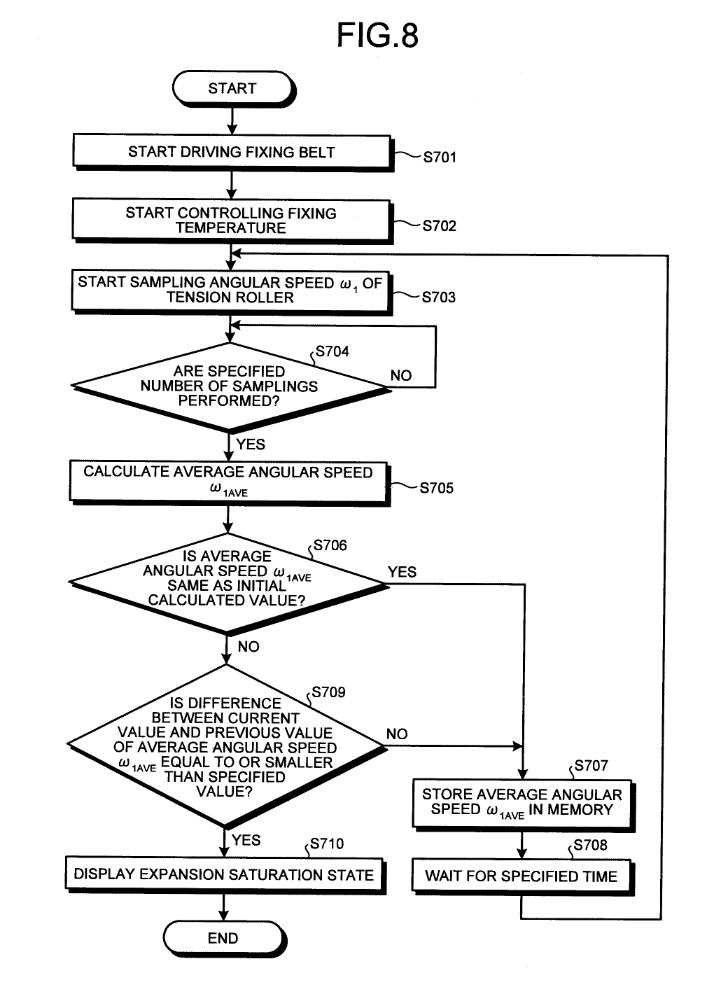

FIG. 8 is a flowchart of an example of processing performed by the control unit 20 in the thermal expansion saturation detection mode. The flow of a series of processing performed by the control unit 20 in the thermal expansion saturation detection mode will be described below with reference to the flowchart of FIG. 8.

When the operation in the thermal expansion saturation detection mode is started, the control unit 20 outputs a constant-speed rotation command to the fixing-roller driving unit to rotate the fixing roller 15 at a constant speed, thereby driving the fixing belt 13 at the constant speed (Step S701).

The control unit 20 controls a fixing temperature so that the surface temperature of the fixing belt 13, which is heated by the heater 22 as a heat source inside the fixing roller 15, becomes the same temperature as that at image formation (Step S702).

The control unit 20 calculates the angular speed ω₁ of the tension roller 16 at specified sampling intervals based on a pulse signal output by the rotary encoder 19, and accumulates the calculated angular speed ω₁ of the tension roller 16 in the memory 21 (Step S703).

The control unit 20 determines whether the angular speed ω₁ is sampled a specified number of times (Step S704). When the number of samplings is smaller than the specified number (No at Step S704), the control unit 20 repeats samplings of the angular speed ω₁ until the number of samplings reaches the specified number. When the number of samplings reaches the specified number (Yes at Step S704), the processing proceeds to Step S705. It is desirable to set the number of times the angular speed ω₁ is sampled so as to correspond to about one turn or even more then one turn of the fixing belt 13 in order to remove noise as described above.

The control unit 20 calculates an average angular speed ω_{1AVE} of the angular speeds ω₁ that are accumulated in the memory 21, where the number of the angular speeds ω₁ accumulated is the same as the specified number of samplings (Step S705).

The control unit 20 determines whether the average angular speed ω_{1AVE} calculated at Step S705 is the same as an initial calculated value (the average angular speed ω_{1AVE} calculated first after the operation in the thermal expansion saturation detection mode is started) (Step S706). When the calculated average angular speed ω_{1AVE} is the same as the initial calculated value (Yes at Step S706), the processing proceeds to Step S707. When the calculated average angular speed ω_{1AVE} is not the same as the initial calculated value (No at Step S706), the processing proceeds to Step S709.

At Step S707, the control unit 20 stores the average angular speed ω_{1AVE} calculated at Step S705 in the memory 21 as a previous value that is an average angular speed ω_{1AVE-1} to be used as a target for comparison at Step S709 in a next processing cycle. The control unit 20 waits for a specified time (Step S708), and thereafter, the processing returns to Step S703 to repeat the same processing for a next processing cycle.

At Step S709, the control unit 20 compares the average angular speed ω_{1AVE} calculated at Step S705 with the previous value stored in the memory 21, i.e., the average angular speed ω_{1AVE-1} calculated in the previous processing cycle, and determines whether a difference between the averages is equal to or smaller than a specified value. When the difference is greater than the specified value (No at Step S709), the processing returns to Step S707, at which the control unit 20 stores the average angular speed ω_{1AVE} calculated at Step S705 in the memory 21 as the previous value and waits for the specified time (Step S708). Thereafter, the processing returns to Step S703 to repeat the same processing for a next processing cycle.

On the other hand, when the difference is equal to or smaller than the specified value (Yes at Step S709), the control unit 20 notifies a factory operator or a serviceman that the thermal expansion of the fixing roller 15 is in the saturation state by displaying message on a display panel or by outputting audio message (Step S710), and ends the series of processing in the thermal expansion saturation detection mode.

It is assumed that the operation in the thermal expansion saturation detection mode is performed just before the nip width is mechanically adjusted to a specified value by a factory operator or a serviceman in a factory before shipment of the color laser printer 100 or on a product delivery site. However, as described above, considering that the nip adjustment amount does not increase when the expansion of the fixing roller 15 is in the saturation state, it is advantageous to notify a user that the expansion of the fixing roller 15 is in the saturation state and perform image formation under this saturation state. From this viewpoint, it is possible to provide the above-mentioned thermal expansion saturation detection mode as one of operation modes that are selectable when the color laser printer 100 is actually operated to perform printing, and notify a user of the saturation state when the expansion of the fixing roller 15 reaches the saturation state.

As has been described in detail with specific examples, according to the fixing device 11 of the embodiment, the control unit 20 calculates the angular speed of the tension roller 16 based on a pulse signal output by the rotary encoder 19 that is set in the tension roller 16, and indirectly detects a variation in the nip width based on a change in the angular speed of the tension roller 16. The control unit 20 operates the nip-width adjusting mechanism 18 in accordance with the amount of change in the angular speed of the tension roller 16, i.e., the amount of variation in the nip width, so as to adjust the nip width to an appropriate value. Therefore, it is possible to adjust the nip width to follow changes in the nip width, making it possible to maintain the nip width at an appropriate value and ensure stable fixability without being provided with a costly strong heat protection measure that is needed for a mechanism to detect the nip width as applied in the conventional technology. In particular, as illustrated in FIGS. 3A and 3B, if the rotary encoder 19 is arranged at a position separated from the roller portion of the tension roller 16, it is possible to extremely reduce heat transfer from the heating roller 14 and the fixing belt 13, which are the heat sources, to the rotary encoder 19. Therefore, it is not necessary to take any measures to protect the rotary encoder 19 from heat or it becomes possible to extremely simplify a heat protection measure. Provided with the fixing device 11, the color laser printer 100 according to the embodiment can stably output high-quality printed object.

The present invention is not limited to the above embodiments, and various changes and modifications may be made without departing from the scope of the present invention. For example, while the rotation speed of the tension roller 16 is measured in the above embodiment, it may be possible to measure a rotation speed of any other driven roller such as the fixing roller 15 instead of the tension roller 16. In this case, it is desirable to arrange the rotary encoder 19, which measures the rotation speed, at a position separated from a roller portion of the driven roller by extending the rotary shaft of the driven roller. With this configuration, it is not necessary to take any measures to protect the rotary encoder 19 from heat or it becomes possible to extremely simplify a heat protection measure. The means for measuring the rotation speed of the tension roller 16 or any other driven roller is not limited to the rotary encoder 19, and any known measuring means capable of measuring the rotation speed of a roller may be applied.

Furthermore, in the above embodiment, the nip-width adjusting mechanism 18 adjusts the nip width based on the rotation speed of the tension roller 16. However, the same advantages as with the direct adjustment of the nip width can be obtained even if other fixing conditions such as the temperature of the fixing belt 13 (related to fixing temperature (corresponding to the amount of heat produced by the heater 22)) or the rotation speed of the fixing roller 15 are adjusted. If the fixing condition to be adjusted is the fixing temperature, it is necessary to stop image formation until the fixing temperature reaches a desired temperature. If the fixing condition to be adjusted is the rotation speed of the fixing roller 15, the productivity may decrease due to decrease in the rotation speed of the fixing roller 15. In contrast, when the nip width is directly adjusted as the fixing condition as in the above embodiment, it is possible to stabilize the fixability of the fixing device 11 without decrease in the productivity.

According to an embodiment of the present invention, the rotation speed of a driven roller is measured and the fixing condition is adjusted based on the measured rotation speed of the driven roller. Therefore, it is possible to optimize the fixing condition in accordance with a variation in the nip width and to stabilize the fixability without need of strong heat protection measures that lead to an increase in costs.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fixing device comprising:
a fixing roller that is driven to rotate;
a fixing belt that is driven by rotation of the fixing roller;
a driven roller that rotates along with the fixing belt;
a pressing member that is pressed against the fixing roller with the fixing belt interposed therebetween to form a nip portion;
a measuring unit that measures a rotation speed of the driven roller; and
a control unit that adjusts a fixing condition based on the rotation speed of the driven roller.

2. The fixing device according to claim 1, wherein
the driven roller has a rotary shaft that is extended in a direction away from the fixing belt, and
the measuring unit is arranged on an extended portion of the rotary shaft.

3. The fixing device according to claim 2, wherein
the measuring unit is an encoder arranged on the extended portion of the rotary shaft.

4. The fixing device according to claim 1, further comprising:
a nip-width adjusting mechanism that adjusts a width of the nip portion by adjusting a position of the pressing member, wherein
the control unit controls operation of the nip-width adjusting mechanism based on the rotation speed of the driven roller, thereby adjusting the width of the nip portion as the fixing condition.

5. The fixing device according to claim 1, wherein
the control unit adjusts a temperature of the fixing belt as the fixing condition based on the rotation speed of the driven roller.

6. The fixing device according to claim 1, wherein
the control unit adjusts a rotation speed of the fixing roller as the fixing condition based on the rotation speed of the driven roller.

7. The fixing device according to claim 1, wherein
the measuring unit performs a number of measurements while the fixing belt is driven for a predetermined distance to obtain rotation speeds of the driven roller, and
the control unit adjusts the fixing condition based on an average of the rotation speeds of the driven roller.

8. The fixing device according to claim 1, further comprising:
a storage unit that stores therein the rotation speed of the driven roller measured by the measuring unit as a reference speed when the nip portion is maintained at an appropriate width, wherein
the control unit adjusts the fixing condition by an amount of adjustment corresponding to a difference between the reference speed stored in the storage unit and the rotation speed of the driven roller measured by the measuring unit.

9. The fixing device according to claim 8, wherein
the measuring unit measures the rotation speed of the driven roller after the control unit has adjusted the fixing condition, and updates the reference speed stored in the storage unit with a value measured of the rotation speed of the driven roller after the control unit has adjusted the fixing condition.

10. The fixing device according to claim 1, wherein
the control unit issues a notice that a thermal expansion of the fixing roller reaches a saturation state when an amount of change between the rotation speed of the driven roller measured by the measuring unit and a previously-measured rotation speed of the driven roller is equal to or smaller than a specified value.

11. The fixing device according to claim 1, wherein
the driven roller, the rotation speed of which is measured by the measuring unit, is a tension roller that applies a tension to the fixing belt.

12. The fixing device according to claim 1, wherein
the driven roller, the rotation speed of which is measured by the measuring unit, is a heating roller that heats the fixing belt.

13. An image forming apparatus comprising:
an image forming unit that forms an image; and
a fixing device that fixes the image to a recording medium, the fixing device including
a fixing roller that is driven to rotate,
a fixing belt that is driven by rotation of the fixing roller,
a driven roller that rotates along with the fixing belt,
a pressing member that is pressed against the fixing roller with the fixing belt interposed therebetween to form a nip portion,
a measuring unit that measures a rotation speed of the driven roller, and
a control unit that adjusts a fixing condition based on the rotation speed of the driven roller.

14. The image forming apparatus according to claim 13, wherein
the driven roller has a rotary shaft that is extended in a direction away from the fixing belt, and
the measuring unit is arranged on an extended portion of the rotary shaft.

15. The image forming apparatus according to claim 14, wherein
the measuring unit is an encoder arranged on the extended portion of the rotary shaft.

16. The image forming apparatus according to claim 13, wherein the fixing device further comprises:
a nip-width adjusting mechanism that adjusts a width of the nip portion by adjusting a position of the pressing member, wherein
the control unit controls operation of the nip-width adjusting mechanism based on the rotation speed of the driven roller, thereby adjusting the width of the nip portion as the fixing condition.

17. The image forming apparatus according to claim 13, wherein
the control unit adjusts a temperature of the fixing belt as the fixing condition based on the rotation speed of the driven roller.

18. The image forming apparatus according to claim 13, wherein
the control unit adjusts a rotation speed of the fixing roller as the fixing condition based on the rotation speed of the driven roller.

19. The image forming apparatus according to claim 13, wherein
the measuring unit performs a number of measurements while the fixing belt is driven for a predetermined distance to obtain rotation speeds of the driven roller, and
the control unit adjusts the fixing condition based on an average of the rotation speeds of the driven roller.

20. A method for controlling a fixing device including:
a fixing roller that is driven to rotate,
a fixing belt that is driven by rotation of the fixing roller,
a driven roller that rotates along with the fixing belt, and
a pressing member that is pressed against the fixing roller with the fixing belt interposed therebetween to form a nip portion,
the method comprising:
measuring a rotation speed of the driven roller; and
adjusting a fixing condition based on the rotation speed of the driven roller.
